(19) United States
(12) Patent Application Publication
(10) Pub. No.: US 2020/0097096 A1
(43) Pub. Date: Mar. 26, 2020

(54) DISPLAYING IMAGES FROM MULTIPLE DEVICES

(71) Applicant: Hewlett-Packard Development Company, L.P., Spring, TX (US)

(72) Inventors: Wen-Shih Chen, Taipei (TW); John Frederick, Houston, TX (US); Syed S Azam, Houston, TX (US); Irene Chou, Houston, TX (US)

(21) Appl. No.: 16/482,330

(22) PCT Filed: Jun. 16, 2017
(86) PCT No.: PCT/US2017/037849

§ 371 Date: Jul. 31, 2019

(51) Int. Cl. G06F 3/023; G09G 5/14; G06F 3/0354; G06F 3/01

(52) U.S. Cl. CPC G06F 3/023; G09G 5/14; G09G 2354/00; G06F 3/03547; G06F 3/013; G06F 3/03543

(57) ABSTRACT

An example system includes a video processing engine. The video processing engine is to combine a plurality of images from a plurality of distinct devices to produce a combined image. The system also includes a display output to display the combined image. The system includes a hub to provide first input data from an input device to a first of the plurality of distinct devices. When combining images, the video processing engine is to emphasize an image from a second of the plurality of distinct devices based on the hub receiving a first type of input. The hub is to provide second input data to the second of the plurality of distinct devices based on the hub receiving a second type of input.

### BACKGROUND

A computing device may be connected to various user interfaces, such as input or output devices. The computing device may include a desktop computer, a thin client, a notebook, a tablet, a smart phone, a wearable, or the like. Input devices connected to the computing device may include a mouse, a keyboard, a touchpad, a touch screen, a camera, a microphone, a stylus, or the like. The computing device may receive input data from the input devices and operate on the received input data. Output devices may include a display, a speaker, headphones, a printer, or the like. The computing device may provide the results of operations to the output devices for delivery to a user.

### BRIEF DESCRIPTION OF THE DRAWINGS

FIG. 1 is a block diagram of an example system to select a computing device to receive input.

FIG. 2 is a block diagram of another example system to select a computing device to receive input.

FIG. 3 is a flow diagram of an example method to select a computing device to receive input.

FIG. 4 is a flow diagram of another example method to select a computing device to receive input.

FIG. 5 is a block diagram of an example computer-readable medium including instructions that cause a processor to select a computing device to receive input.

FIG. 6 is a block diagram of another example computer-readable medium including instructions that cause a processor to select a computing device to receive input.

### DETAILED DESCRIPTION

A user may have multiple computing devices. To interact with the computing devices, the user could have input and output devices for each computing device. However, the input and output devices may occupy much of the space available on a desk. The large number of input and output devices may be inconvenient and not ergonomic for the user. For example, the user may move or lean to use the various keyboards or mice. The user may have to turn to view different displays, and repeatedly switching between displays may tax the user. In addition, the user may be able to use a limited number of input devices and have a limited field of vision at any particular time.

User experience may be improved by connecting a single set of input or output devices to a plurality of computing devices. To prevent unintended input, the input devices may provide input to a single computing device at a time. In some examples, the output devices may receive output from a single computing device at a time. For example, the input or output devices may be connected to the plurality of computers by a keyboard, video, and mouse (“KVM”) switch, which may be used to switch other input and output devices in addition to or instead of a keyboard, video, and mouse. The KVM may include a mechanical interface, such as a switch, button, knob, etc., for selecting the computing device coupled to the input or output devices. In some examples, the KVM switch may be controlled by a key combination. For example, the KVM may change the selected computing device based on receiving a key combination that is unlikely to be pressed accidentally.

Using one output device at a time, such as displaying one graphical user interface at a time, may be inconvenient for a user. For example, the user may wish to refer quickly between displays. Accordingly, the user experience may be improved by combining the outputs from the plurality of computing providing the combination as a single output. It may also be inconvenient for the user to operate a mechanical interface or enter a particular key combination to change the computing device connected to the input device. Accordingly, the user experience may be improved by providing convenient or rapid inputs for selecting the computing device connected to the input devices or automatically selecting the computing device connected to the input devices without deliberate user input.

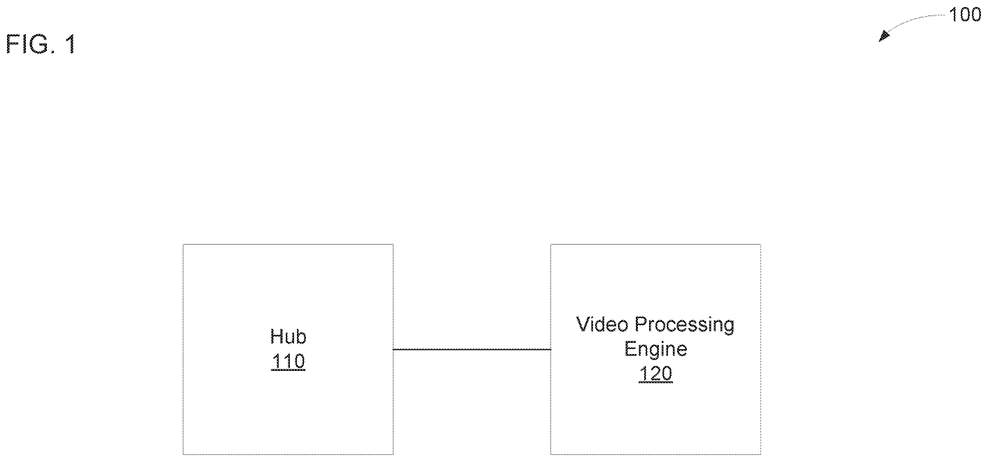

FIG. 1 is a block diagram of an example system 100 to select a computing device to receive input. The system 100 may include a hub 110. The hub 110 may implemented as an engine 110. As used herein, the term “engine” refers to hardware (e.g., a processor, such as an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or executed or interpreted by a processor), or hardware and software hosted at hardware. The hub 110 may be able to provide input data from an input device to one of a plurality of distinct devices, such as a plurality of distinct computing devices. As used herein, the term “distinct” refers to devices that do not share an input port. In some examples, distinct devices may not share an engine for processing received input or may not share an output port. The hub 110 may receive the input data from the input device, and the hub 110 may provide the received input to the determined device.

The system 100 may include a video processing engine 120. The video processing engine 120 may combine a plurality of images from the plurality of distinct devices to produce a combined image. The video processing engine 120 may combine the plurality of images so the images do not overlap with one another. For example, the video processing engine 120 may by placing the individual images adjacent to each other in the combined image. In an example with four distinct devices, the video processing engine 120 may combine the individual images in an arrangement two images high and two images wide.

The hub 110 may receive a first type of input. Based on the hub 110 receiving the first type of input, the video processing engine 120 may emphasize an image from one of the plurality of devices when combining the images from the plurality of devices. The hub 110 may receive a second type of input. Based on the receiving the second type of input, the hub 110 may provide input data to one of the plurality of devices different from the one to which it was previously providing data. For example, the hub 110 may change the destination for the input data based on the second type of input.

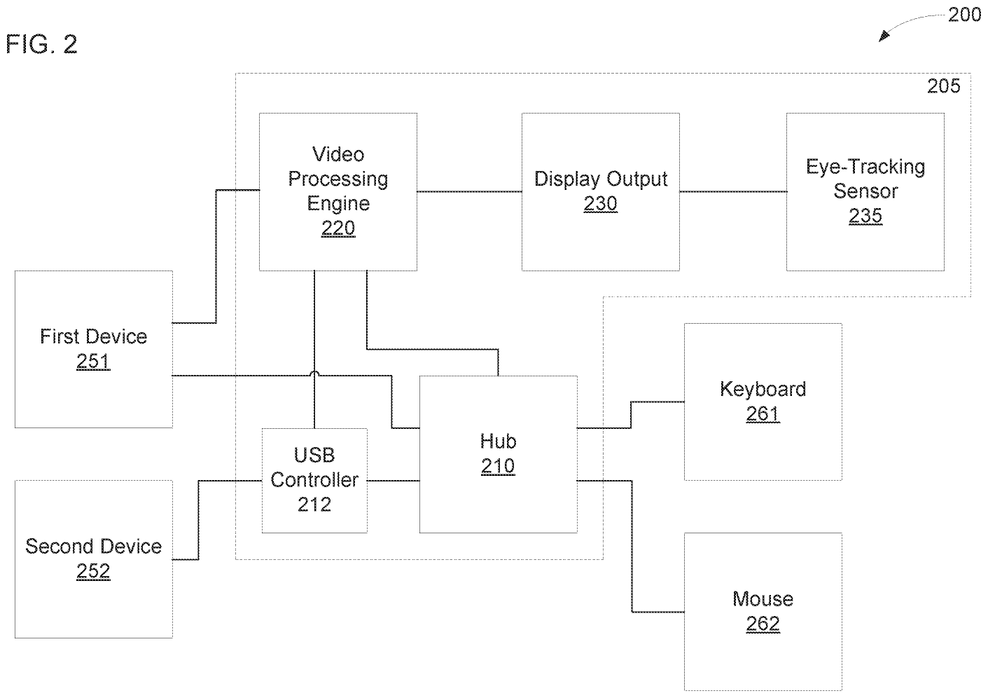

FIG. 2 is a block diagram of another example system 205 to select a computing device to receive input. The example system 205 may include a hub 210. The hub 210 may be communicatively coupled to a first device 251 and a second device 252. The first and second devices 251, 252 may be computing devices. The first and second computing devices 251, 252 may provide output data to the hub 210 and receive input data from the hub 210. The output data may include video data, audio data, printer data, or the like. The hub 210 may be coupled to each device by separate connections carrying input data and output data respectively, by a single connection carrying input and output data, or the like. For example, the first device 251 may include a video output (e.g., High-Definition Multimedia Interface (HDMI), DisplayPort (DP), etc.) connected directly to a video processing engine 220 and an input interface (e.g., Universal Serial Bus (USB), Personal System/2 (PS/2), etc.) connected directly to the hub 210. The second device 252 may include a single USB connection carrying DP data and input data. A USB controller 212 may provide the DP data to the video processing engine 220 and provide input data from the hub 210 to the second device 252. The hub 210 may also be coupled to a keyboard 261 and a mouse 262. The hub 210 may receive input data from the keyboard 261 and the mouse 262. In some examples, the hub 210 may receive input data from other input devices, such as a microphone, a stylus, a camera, etc. The hub 210 may provide the input data to the first or second device 251, 252. For example, the hub 210 may provide the input to a selected one of the devices 251, 252, fewer than all devices 251, 252, all devices 251, 252, or the like.

The system 205 may include the video processing engine 220 and a display output 230. In an example, the video processing engine 220 may include a scaler. The video processing engine 220 may combine a plurality of images from a plurality of distinct devices to produce a combined image. The video processing engine 220 may reduce the size of the images and position the images adjacent to each other to produce the combined image (e.g., side-by-side, one on top of the other, or the like). The images may overlap or not overlap, include a gap or not include a gap, or the like. The video processing engine 220 may provide the combined image to the display output 230, and the display output 230 may display the combined image. As used herein, the term “display output” refers to the elements of the display that control emission of light of the proper color and intensity. For example, the display output 230 may include an engine to control light emitting elements, liquid crystal elements, or the like.

The video processing engine 220 may emphasize an image from the second device 252 based on the hub 210 receiving a first type of input. In an example, an image from the first device 251 or none of the images may have been emphasized prior to receiving the first type of input. The emphasis may include increasing a size of the image relative to a remainder of the images. The emphasized image may overlap the remaining images, or the size of the remaining images may be modified to accommodate the increased size. The video processing engine 220 may add a border to the emphasized image, such as a border with a distinct or noticeable color or pattern, a border with a flashing or changing color, or the like. In some examples, the user may select the color of the border.

In an example, the hub 210 may detect the first type of input. The hub 210 or the video processing engine 220 may analyze the first type of input to determine which image should be emphasized. In an example, the first type of input may be a mouse pointer position (e.g., an indication of change in position, relative position, absolute position, or the like). The hub 210 or video processing engine 220 may determine the image to be emphasized based on the position. For example, the hub 210 or video processing engine 220 may determine the position of the mouse 261 based on indications of mouse movement, and the hub 210 or video processing engine 220 may determine the image over which the mouse is located based on the indications of the mouse movement. The video processing engine 220 may emphasize the image over which the mouse is located.

In an example, the system 205 may include an eye-tracking sensor 235. The eye-tracking sensor 235 may measure the gaze direction directly (e.g., based on an eye or pupil position) or indirectly (e.g., based on a head orientation detected by a camera, a head or body position or orientation based on a time of flight sensor measurement, etc.). The first type of input may include the directly or indirectly measured eye gaze direction (e.g., the direction itself, information usable to compute or infer the direction, or the like). For example, the hub 210 or video processing engine 220 may determine the image to which the eye gaze is directed, and the video processing engine 220 may emphasize the determined image. In examples, the first type of input may be a mouse button (e.g., a button click, a scroll wheel manipulation, etc.), a mouse movement, a mouse position on a mouse pad, a keyboard input, a touchpad input (e.g., a gesture, a swipe, etc.), a position of a user's chair, a microphone input, or the like

The hub 210 may provide input data to the second device 252 based on the hub 210 receiving a second type of input. For example, the hub 210 may switch an input target from the first device 251 to the second device 252 based on the hub 210 receiving the second type of input. As used herein, the term “input target” refers to a device to which the hub 210 is currently providing input data. In an example, received input data may have been provided to the first device 251 or none of the devices prior to receiving the second type of input. The second type of input may be different from the first type of input. Accordingly, the emphasized image may or may not be from the device receiving input depending on the first and second types of inputs. In an example, the second type of input may be a mouse button (e.g., a button click, a scroll wheel manipulation, etc.), a mouse movement or position, a keyboard input, a touchpad input, a position of a user's chair, a microphone input, or the like. For example, an image from the second device 252 may be emphasized based on the mouse 261 being positioned over the image from the second 252, but directing an input to the second device 252 may further involve a click on the image from the second device 252, a particular mouse button click, a particular mouse movement, a particular keyboard input (e.g., a unique key combination, etc.), a particular touchpad input (e.g., a unique gesture, swipe, etc.), or the like.

In an example, the hub 210 may change the device to receive inputs based on button clicks on the mouse 261. For example, a first button may move through the devices in a first order, and a second button may move through the devices in a second order (e.g., a reverse of the first order). In an example, a single button may be used to select the next device without another button to proceed through a different order. The buttons may include left or right buttons, buttons on the side of the mouse 261, a scroll wheel, or the like. In some examples, the user may press a particular button or set of buttons or a particular key combination to enter a mode that permits the user to change which device is to receive input. For example, the user may press the left and right buttons at the same time to trigger a mode in which the device to receive input can be changed, and the user may press the left or right buttons individually to change which device is to receive input.

The hub 210 or the mouse 261 may detect unique mouse movements, such as rotation of the mouse 261 counterclockwise to move through the devices in a first order and rotation of the mouse 261 clockwise to move through the devices in a second order (e.g., a reverse of the first order), lifting the mouse 261 and moving it vertically, horizontally, etc. (e.g., to indicate an adjacent image corresponding to a device to receive input, to move through the devices in a particular order, etc.), the mouse 261 remaining positioned over an image associated with the device to receive input for a predetermined time, or the like. The mouse 261 may be able to detect its location on a mouse pad (e.g., based on a color of the mouse pad, a pattern on the mouse pad, a border between portions of the mouse pad, transmitters in the mouse pad, etc.) and indicate to the hub 210 the portion of the mouse pad on which the mouse 261 is located. The user may move the mouse 261 to a particular location on the mouse pad to change which display is to receive input. For example, the mouse pad may include four quadrants (e.g., with a unique color or pattern for each quadrant) corresponding to four connected devices, and the hub 210 may direct input to the device associated with the quadrant in which the mouse 261 is located. The hub 210 may change the device to receive input any time the user moves the mouse 261 to the particular location, or the hub 210 may change the device based on the hub 210 initially entering a mode in which the device can be changed prior to moving the mouse 261 to the particular location. In some examples, the scalar 220 may display a list of devices and indicate which is to receive input when the user changes the device to receive input or enters a mode to change which device is to receive input. In an example, the user may be able to click a displayed device name to begin directing input to that device.

In an example, the hub 210 may change the device to receive input based on an eye gaze direction (e.g., an eye gaze direction directly or indirectly measured by the eye-tracking sensor 235). For example, the hub 210 may direct input to the first device 251 based on determining the eye gaze is directed towards a first image associated with the first device. The hub 210 may direct the input to the first device 251 immediately after the hub 210 determines the eye gaze is directed to the first image, or the hub 210 may direct the input to the first device based on determining the eye gaze has been directed towards the first image for a predetermined time. For example, the scalar 220 may emphasize the first image based on the hub 210 determining the eye gaze is directed towards the first image, and the hub 210 may direct input to the first device 251 based on determining the eye gaze has been directed towards the first image for a predetermined time (e.g., 0.5 seconds, one second, two seconds, five seconds, ten seconds, etc.). The hub 210 may reset or cancel a timer that measures the predetermined time if another input is received before the predetermined time is reached (e.g., changing of the input target may be delayed or may not occur based on eye gaze if mouse or keyboard input is received).

The hub 210 may determine the image to emphasize or the device to receive input based on an input from a keyboard 262. For example, a particular key combination may select an image to be emphasize, a device to receive input, move through the image to select one to be emphasized, move through the devices 251, 252 to select one to be emphasized, or the like. Different key combinations may move through the images or devices in different directions. There may be a first key combination or set of key combinations to select the image to be emphasized and a second key combination or set of key combinations to select the device to receive input. A particular key combination may cause the hub 210 to enter a mode in which the image or device may be selected. Other keys (e.g., arrow keys), mouse buttons, mouse movement, or the like may be used to select the image or device once the mode is entered. For example, a first key combination may enter a mode in which the scroll wheel selects the image to be emphasized, and a second key combination may enter a mode in which the scroll wheel selects the device to receive input. In an example, a chair may include a sensor to detect rotation of the chair and to indicate the position to the hub 210. The hub 210 or the scalar 220 may select the image to be emphasized or the device to receive input based on the chair position. The hub 210 may receive input from a microphone, and the hub 210 or the scalar 220 may select the image to be emphasized or the device to receive input based on vocal commands from a user.

In some examples, the hub 210 may determine whether a change in input target device is intended based on the input. For example, the hub 210 may analyze the type of the input, the context of the input, the content of the input, previous inputs, etc. to determine whether a change in input target is intended. In an example, the hub 210 or the scalar 220 may determine a change to which image is to be emphasized in the combined image based on the input, but the hub 210 may further analyze the input to determine whether a change in the input target should occur as well. By determining the intent of the user, the hub 210 may automatically adjust the input target without explicit user direction so as to provide a more efficient and enjoyable user experience.

In an example, the hub 210 may determine the intended input target based on whether a predetermined time has elapsed since providing previous input data to the current target device. For example, the user may move the mouse pointer to an image associated with a device other than the current input target. The user may begin typing, and the hub 210 may determine whether to direct the keyboard input to the current device or the other device based on the time since the last keyboard input, mouse click, etc. to the current device (e.g., the hub 210 may change the input target if the time is greater than or at least a predetermined threshold, may change the input target if the time is less than or at most the predetermined threshold, etc.). Similarly, the hub 210 or the scalar 220 may determine a change to the emphasized image based on eye gaze, but the hub 210 may determine whether to change the input target based on the time since the last keyboard or mouse input, the duration of the eye gaze at the newly emphasized image, or the like.

In an example, the hub 210 may determine whether a change in input target from the first device 251 to the second device 252 is intended based on whether the input is directed to an interactive portion of the second device 252. For example, the user may move the mouse pointer to or direct their eye gaze towards an image associated with the second device 252. The hub 210 may determine whether the mouse pointer or eye gaze is located at or near a portion of the user interface of the second device 252 that is able to receive input. If the user moves the mouse pointer or eye gaze to a text box, a link, a button, etc., the hub 210 may determine a change in input is intended. In an example, the hub 210 may analyze a subsequent input to decide whether it matches the type of the interactive portion. For example, the hub 210 may change the input target if the interactive portion is a button or link and the subsequent input is a mouse click but not if the subsequent input is a keyboard input. If the interactive portion is a text box, the hub 210 may change the input target if the subsequent input is a keyboard input but not if it is a mouse click. The hub 210 may determine the interactive portions based on receiving an indication of the locations of the interactive portions from the second device 252, based on the second device 252 indicating whether the mouse pointer or eye gaze is currently directed to an interactive portion, based on typical locations of interactive portions (e.g., preprogrammed locations), based on previous user interactions, or the like.

The hub 210 may further analyze the type of a subsequent input to determine whether to change the input target. For example, the user may move a mouse pointer or eye gaze to an image associated with another device. The hub 210 may change the input target to the other device if the subsequent input is a mouse click but not if the subsequent input is a keyboard input. In an example, the user may enter a key combination to change which image is emphasized, and the hub 210 may change the input target if the subsequent input is a keyboard input but not if the subsequent input is a mouse click or the like. In some examples, different types of input may be directed at different input targets. For example, a keyboard input may be directed to a device associated with a current eye gaze direction but a mouse click may be directed to a device associated with the location of the mouse pointer regardless of current eye gaze direction.

The hub 210 may analyze the contents of the input to determine whether a change in input target is intended. For example, the hub 210 may determine whether the content of the input matches the input to be received by an interactive portion. A mouse click or alphanumeric typing may not change the state of an application or the operating system unless at specific portions of a graphical user interface whereas a scroll wheel input or keyboard shortcut may create a change in state when received at a larger set of locations of the graphical user interface. The hub 210 may determine whether the content of the input will result in a change of state of the application or operating system to determine whether a change in input target is intended. In an example, the hub 210 may associate particular inputs with an intent to change the input target. For example, the hub 210 may associate a particular keyboard shortcut with an intent to change the input target. The hub 210 may change the input target to a device associated with a currently emphasized image if that particular keyboard shortcut is received but not change the input target if, e.g., a different keyboard shortcut, alphanumeric text, or the like is received.

The hub 210 may analyze previous input to determine whether a change in the input target is intended. For example, the user may be able to select the input target using a mouse click, keyboard shortcut, or the like. The hub 210 may analyze the user's previous changes in input target (e.g., device states, inputs received, body position, eye gaze path, etc. at or prior to the change in input target) to determine the probability a change in input target is intended in any particular situation. The hub 210 may apply a deep learning algorithm to determine whether a change in input target is intended, for example, the hub 210 may train a neural network based on, e.g., device states, inputs received, body position, eye gaze path, etc. at or prior to the change in input target. In an example, the hub 210 may determine interactive portions of the graphical user interfaces of the devices based on the locations of mouse clicks, mouse clicks which are followed by keyboard inputs, keyboard shortcuts, scroll wheel inputs, or the like. The hub 210 may determine whether to change the input target based on the interactive portions as previously discussed.

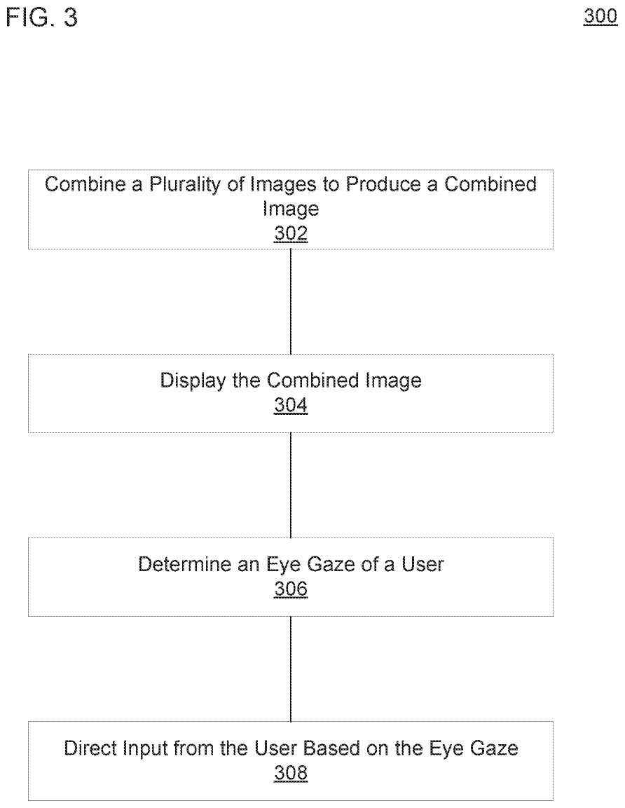

FIG. 3 is a flow diagram of an example method 300 to select a computing device to receive input. A processor may perform the method 300. At block 302, the method 300 may include combining a plurality of images from a plurality of distinct devices to produce a combined image. For example, the plurality of images may be resized and positioned adjacent to each other to produce the combined image. Block 304 may include displaying the combined image. Displaying the combined image may include emitting light at particular intensities, colors, and locations so that a user is able to view the combined image.

At block 306, the method 300 may include determining an eye gaze of the user is directed towards a first of the plurality of images. The first of the plurality of images may be associated with a first of the plurality of distinct devices. The user may be analyzed to determine the eye gaze direction. The locations of the images may be calculated or known, so the eye gaze direction may be compared to the image locations to determine towards which image the eye gaze is directed. Block 308 may include directing input from the user to the first of the plurality of distinct devices based on determining the eye gaze is directed towards the first of the plurality of images. The input may be transmitted or made available to the device associated with the image towards which the eye gaze is directed. Referring to FIG. 2, in an example, the video processing engine 220 may perform block 302, the display output 230 may perform block 304, the eye-tracking sensor 235, the video processing engine 220, or the hub 210 may perform block 306, and the hub 210 may perform block 308.

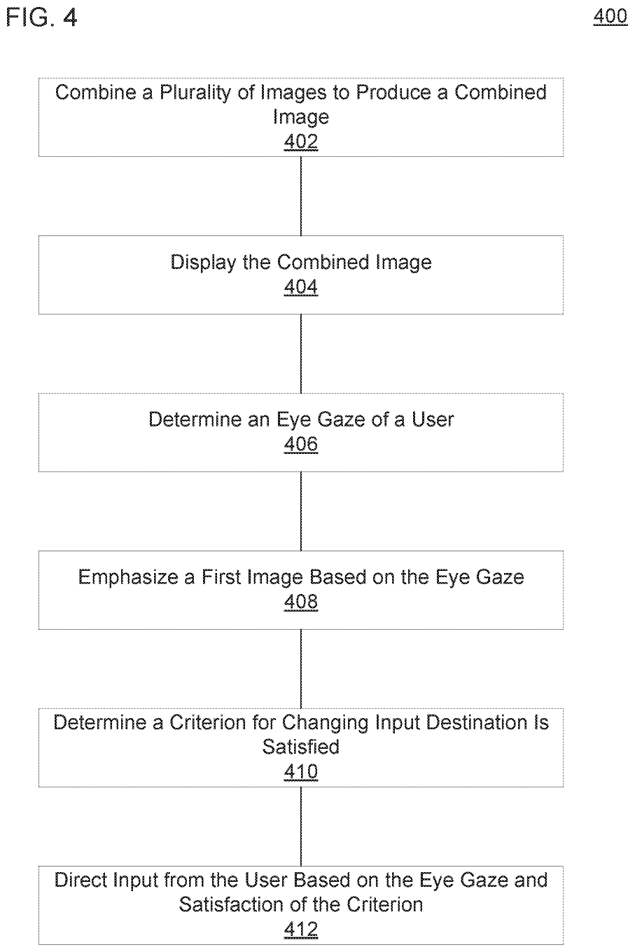

FIG. 4 is a flow diagram of another example method 400 to select a computing device to receive input. A processor may perform the method 400. At block 402, the method 400 may include combining a plurality of images from a plurality of distinct devices to produce a combined image. For example, each image may be received from the corresponding device over a wired or wireless connection. The images may be resized, and the images may be positioned adjacent to each other produce the combined image. The images may overlap, may include a gap between the images, may neither overlap nor include a gap, or the like. Block 404 may include displaying the combined image. For example, the color and intensity of each pixel in the combined image may be recreated by adjusting the intensity of light emitted by a light emitter, by adjusting a shutter element to control the intensity of emitted light, or the like.

Block 406 may include determining an eye gaze of the user is directed towards a first of the plurality of images. The first of the plurality of images may be associated with a first of the plurality of distinct devices. The eye gaze may be determined by measuring pupil position, measuring head position or orientation, measuring body position or orientation, or the like. The head or body position or orientation may be measured by a time of flight sensor, a camera, or the like. The pupil position may be measured by an infrared or visible light camera or the like. The locations of the images relative to the measuring instrument may be known, and the distance of the user from the computer may be measured by the camera or time of flight sensor. So, the image at which the user is gazing can be computed from the eye gaze, the distance of the user, and the known image locations.

Block 408 may include emphasizing the first image based on determining the eye gaze is directed towards the first image. Emphasizing the first image may include increasing the size of the first image. The size of the other images may remain the same, or the other images may be reduced in size. As a result, the first image may increase in size relative to the other images. Due to the increase in size, the first image may overlap the other images; there may be gaps between the edges of the images; or there may be neither overlap nor gaps. The eye gaze tracking ensures that whichever image is being viewed by the user is emphasized relative to the other images. Accordingly, the image in use is more visible to the user than if all images were equally sized while still displaying all images simultaneously. In some examples, emphasizing the first image may include adding a border to the image. The border may include a color (e.g., a distinctive color easily recognizable by the user), a pattern (e.g., a monochrome patter, a color pattern, etc.), or the like.

At block 410, the method 400 may include determining a criterion for changing the input destination is satisfied. In an example, the criterion may include towards which image is the user's eye gaze currently directed. The input may be provided to the device associated with whichever image the user is currently viewing. The criterion may include the user's eye gaze being directed towards the image for a predetermined time. For example, as the user's eye gaze moves among the images, the images may be emphasized. However, the input destination may not change until the user has viewed the image for a predetermined period of time. If the user provides input before the predetermined time has elapsed, the input may be provided to a previous input destination. A timer measuring the predetermined time may be restarted if input is received, or the predetermined time may be increased. In an example, the input may be provided to the previous input destination at least until the user has directed their eye gaze towards a new input destination. The criterion may include a type of input, the content of the input, the context of the input, previous inputs, etc. For example, input may be directed to a device associated with an image currently receiving the user's gaze when the input is a keyboard input but not other types of input. In an example, keyboard input may be directed to a previously input target, but other types of input may be directed to the device associated with the image currently receiving the user's gaze. Satisfaction of the criterion may be indicated to the user visually, for example, by changing the color or pattern of the border, flashing the image, adjusting the image size, or the like.

Block 412 may include directing input from the user to the first device based on determining the user's eye gaze is directed towards the first of the plurality of images and the satisfaction of the criterion. Input may be received from various input devices. An indication of the current input target may be saved, or the current input target may be determined based on the received input. The input may be transmitted or provided to the input target. For example, the input may be transmitted as if the input device were directly connected to the input target, may be transmitted with an indication of the input device from which the input was received, or the like. Referring to FIG. 2, in some examples, the video processing engine 220 may perform blocks 402, 406, 408, or 410; the display output 230 may perform block 404; the eye tracking sensor 235 may perform block 406; and the hub 210 may perform blocks 410 or 412.

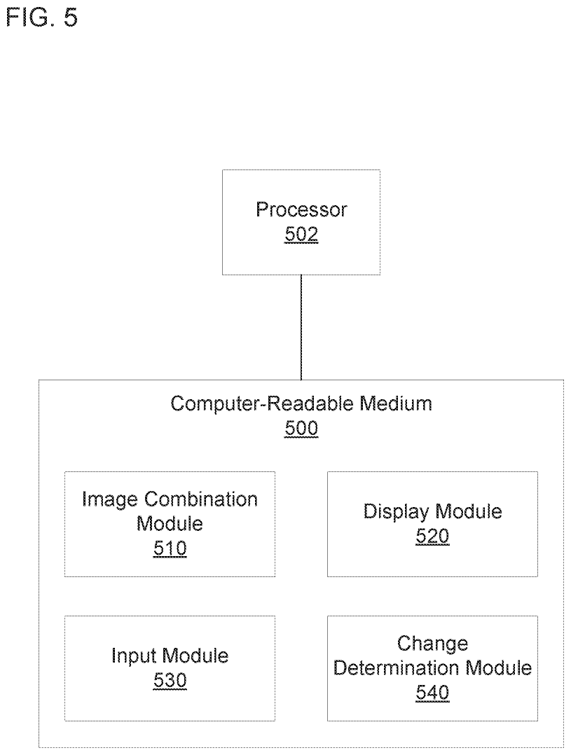

FIG. 5 is a block diagram of an example computer-readable medium 500 including instructions that, when executed by a processor 502, cause the processor 502 to select a computing device to receive input. The computer-readable medium 500 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 502 may be a general purpose processor or special purpose logic, such as a microprocessor, a digital signal processor, a microcontroller, an ASIC, an FPGA, a programmable array logic (PAL), a programmable logic array (PLA), a programmable logic device (PLD), etc.

The computer-readable medium 500 may include an image combination module 510. As used herein, a “module” (in some examples referred to as a “software module”) is a set of instructions that when executed or interpreted by a processor or stored at a processor-readable medium realizes a component or performs a method. The image combination module 510 may include instructions that, when executed, cause the processor 502 to combine a first plurality of images from a plurality of distinct devices to produce a first combined image. For example, the image combination module 510 may cause the processor 502 to position the images adjacent to each other to produce the first combined image. In the first combined image, the individual images may overlap, may include gaps between them, neither, or both.

The computer-readable medium 500 may include a display module 520. The display module 520 may cause the processor 502 to provide the first combined image to a display output. For example, the display module 520 may cause the processor 502 to transmit the first combined image to the display output, to provide the first combined image to the display output (e.g., store the first combined image in a location accessible to the display output), or the like. The display output may cause light to be emitted to display the first combined image.

The computer-readable medium 500 may include an input module 530. The input module 530 may cause the processor 502 to provide first input data from an input device to a first of the plurality of distinct devices. For example, the input module 530 may cause the processor 502 to transmit or make available the first input data for the first device. The computer-readable medium 500 may include a change determination module 540. The change determination module 540 may cause the processor 502 to analyze input data. The change determination module 540 may cause the processor 502 to determine whether a first type of input has been received and whether to change an emphasized image based on the first type of input. The first input data may include the first type of input or later input data may include the first type of input. The input module 530 may cause the processor 502 to provide input data containing the first type of input to the first device or to refrain from providing the input data containing the first type of input to the first device.

The image combination module 510 may cause the processor 502 to combine a second plurality of images from the plurality of distinct devices to produce a second combined image. The second plurality of images may include an image from a second of the plurality of distinct devices. The image combination module 510 may cause the processor 502 to emphasize the image from the second device in the second combined image based on the receipt of the first type of input. For example, the image combination module 510 may cause the processor 502 to receive image continuously from the devices. The change determination module 540 may cause the processor 502 to indicate to the image combination module 510 which device should have its images emphasized. The image combination module 510 may cause the processor 502 to emphasize images from that device when combining the images.

The change determination module 540 may cause the processor 502 to determine whether a change in input target is intended based on the first type of input. For example, the change determination module 540 may cause the processor 502 to analyze the type of the input, the content of the input, the context of the input, previous inputs, or the like to determine whether a change in input target is intended. Based on the change determination module 540 causing the processor 502 to determine a change is intended, the input module 530 may cause the processor 502 to provide second input data to the second of the plurality of devices. Based on the change determination module 540 causing the processor 502 to determine a change is not intended, the input module 530 may cause the processor 502 to provide the second input data to the first of the plurality of devices. In some examples, the image combination module 510, the display module 520, or the change determination module 540, when executed by the processor 502, may realize the scalar 120 of FIG. 1, and the input module 530 or the change determination module 540 may realize the hub 110.

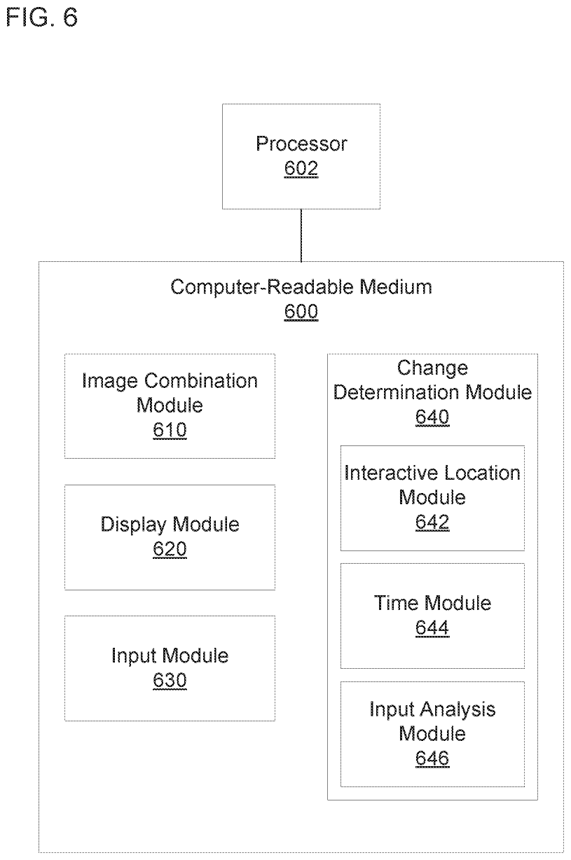

FIG. 6 is a block diagram of another example computer-readable medium 600 including instructions that, when executed by a processor 602, cause the processor 602 to select a computing device to receive input. The computer-readable medium 600 may include an image combination module 610. The image combination module 610, when executed by the processor 602, may cause the processor 602 to combine a first plurality of images from a plurality of distinct devices to produce a first combined image. The computer-readable medium 600 may include a display module 620, which may cause the processor 602 to provide the first combined image to a display output. The computer-readable medium 600 may also include an input module 630, which may cause the processor 602 to provide first input data from an input device to a first of the plurality of distinct devices.

The computer-readable medium 600 may include a change determination module 640. The change determination module 640 may cause the processor 602 to analyze input data received by the input module 630. The change determination module 640 may cause the processor 602 to determine when to change which image is emphasized by the image combination module 610 when combining images or when to change the destination for input received by the input module 630. In an example, the change determination module 640 may cause the processor 602 to determine whether to change the image that is emphasized based on a first type of input. For example, the change determination module 640 may cause the processor 602 to analyze mouse position to determine which image should be emphasized. The image corresponding to the mouse's current location may be emphasized. The change determination module 640 may cause the processor 602 to analyze keyboard input to determine whether a particular key combination has been received. Thus, the change determination module 640 may determine which image to emphasize based on the receipt of the first type of input. Based on the determination of which image to emphasize, the image combination module 610 may cause the processor 602 to combine, e.g., a second plurality of images from the plurality of distinct devices to produce a second combined image. The image combination module 610 may emphasize an image from a second device when combining the second plurality of images.

The change determination module 640 may cause the processor 602 to determine whether a change in input target is intended based on the first type of input. For example, the change determination module 640 may cause the processor 602 to analyze the type of the input, the context of the input, the content of the input, previous inputs, or the like to determine whether the user intends a change in input target. The change determination module 640 may include an interactive location module 642. The interactive location module 642 may cause the processor 602 to determine whether the first type of input is directed to an interactive portion of the image from the second device. In an example, the interactive location module 642 may cause the processor 602 to determine the user intends to change the input target based on the first type of input being directed to the interactive portion and to determine the user does not intend to change the input target based on the first type of input not being directed to the interactive portion. For example, the first type of input may be a mouse position, an eye gaze, or the like. The interactive location module 642 may cause the processor 602 to determine whether the mouse position or eye gaze is directed towards an interactive portion of the image from the second device.

The change determination module 640 may include a time module 644. The time module 644 may cause the processor 602 to determine whether a predetermined time has elapsed since providing the first input data to the first device. In an example, the time module 644 may cause the processor 602 to determine a change is not intended if less than or at most the predetermined time has elapsed and a change is intended if more than or at least the predetermined time has elapsed. The time module 644 may cause the processor 602 to continue to monitor the time between subsequent inputs. If the time between subsequent inputs exceeds the predetermined time, the time module 644 may cause the processor 602 to determine a change is intended. The time threshold for subsequent inputs may be larger, smaller, or the same as the predetermined time used initially when the emphasized image is changed. In an example, the time module 644 may cause the processor 602 to no longer monitor whether the predetermined time has elapsed after the emphasized image is changed, e.g., until the emphasized image is changed again.

The change determination module 640 may include an input analysis module 646. The input analysis module 646 may cause the processor 602 to learn when the user intends to change the input target based on previous user requests to change the input target. For example, the change determine module 640 may cause the processor 602 to determine the input target based on receipt of a second type of input. For example, the user may click on the input target, enter a particular key combination, or the like. The input analysis module 646 may cause the processor 602 to analyze previous occasions the second type of input was received. For example, the input analysis module 646 may cause the processor 602 to generate rules, to apply a deep learning algorithm, or the like. The input analysis module 646 may cause the processor 602 to analyze inputs leading up to the request to change input target (e.g., timing, content, etc.), inputs subsequent to the request to change input target (e.g., timing, content, etc.), the content of the first type of input (e.g., a mouse or eye gaze position in the second image, a timing of key presses when entering a key combination, etc.), or the like. The input analysis module 646 may cause the processor 602 to determine whether a change is intended with the first type of input based on the analysis of previous receipt of the second type of input. Referring to FIG. 2, the image combination module 610, the display module 620, or the change determination module 640 (e.g., including the interactive location module 642, the time module 644, or the input analysis module 646), when executed by the processor 602, may realize the scalar 220 in an example, and the input module 630 or the change determination module 640 (e.g., including the interactive location module 642, the time module 644, or the input analysis module 646) may realize the hub 210.

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a video processing engine to combine a plurality of images from a plurality of distinct devices to produce a combined image; and
a hub to provide first input data from an input device to a first of the plurality of distinct devices,
wherein when combining the images, the video processing engine is to emphasize an image from a second of the plurality of distinct devices based on the hub receiving a first type of input, and
wherein the hub is to provide second input data to the second of the plurality of distinct devices based on the hub receiving a second type of input.

2. The system of claim 1, wherein the first type of input comprises a mouse pointer positioned over the image from the second device and the second type of input comprises one selected from the group consisting of a mouse button, a mouse movement, a keyboard input, and a touchpad input.

3. The system of claim 1, further comprising an eye-tracking sensor, wherein the first type of input comprises an eye gaze at the image from the second device and the second type of input comprises an input selected from the group consisting of a mouse click on the image from the second device and an eye gaze for a predetermined length of time.

4. The system of claim 1, wherein the video processing engine is to emphasize the image from the second device by performing an action selected from the group consisting of increasing a size of the image from the second device relative to a remainder of the plurality of images and adding a border to the image from the second device, and wherein the video processing engine is to modify the border based on the hub receiving the second type of input.

5. The system of claim 1, wherein one of the first type of input and the second type of input comprises an indication from a mouse of a portion of a mouse pad at which the mouse is located.

6. A method, comprising:
combining a plurality of images from a plurality of distinct devices to produce a combined image;
displaying the combined image;
determining an eye gaze of a user is directed towards a first of the plurality of images, the first of the plurality of images associated with a first of the plurality of distinct devices; and
directing input from the user to the first of the plurality of distinct devices based on the determining the eye gaze is directed towards the first of the plurality of images.

7. The method of claim 6, further comprising emphasizing the first image based on determining the eye gaze is directed towards the first image.

8. The method of claim 7, wherein directing the input to the first device comprises directing the input to the first device based on determining the eye gaze has been directed towards the first image for a predetermined time.

9. The method of claim 6, wherein determining the eye gaze is directed towards the first image comprises determining a direction of the eye gaze based on one selected from the group consisting of a determination of eye position, a time of flight sensor measurement, and a determination of an orientation of the user's head.

10. The method of claim 6, wherein directing the input to the first device comprises directing the input to the first device based on determining the eye gaze is directed towards the first image and the input is a keyboard input.

11. A non-transitory computer-readable medium comprising instructions that, when executed by a processor, cause the processor to:
combine a first plurality of images from a plurality of distinct devices to produce a first combined image;
provide the first combined image to a display output;
provide first input data from an input device to a first of the plurality of distinct devices;
combine a second plurality of images from the plurality of distinct devices to produce a second combined image, the second plurality of images including an image from a second of the plurality of distinct devices, the image from the second of the plurality of distinct devices emphasized in the second combined image based on receipt of a first type of input;
determine whether a change in input target is intended based on the first type of input;
based on a change in input being intended, provide second input data to the second of the plurality of distinct devices; and
based on a change in input not being intended, provide the second input data to the first of the plurality of distinct devices.

12. The computer-readable medium of claim 11, wherein the instructions that cause the processor to determine whether the change in the input target is intended include instructions that cause the processor to determine whether the first type of input is directed to an interactive portion of the image from the second device.

13. The computer-readable medium of claim 12, wherein the first type of input is selected from the group consisting of a mouse over the interactive portion and an eye gaze at the interactive portion.

14. The computer-readable medium of claim 11, wherein the instructions that cause the processor to determine whether the change in the input target is intended include instructions that cause the processor to determine whether a predetermined time has elapsed since providing the first input data to the first device.

15. The computer-readable medium of claim 11, further comprising instructions that cause the processor to determine the input target based on receipt of a second type of input, and wherein the instructions that cause the processor to determine whether the change in the input target is intended based on the first type of input include instructions that cause the processor to determine whether the change is intended based on analysis of previous receipt of the second type of input.
